(19) United States
(12) Patent Application Publication
(10) Pub. No.: US 2011/0030916 A1
(43) Pub. Date: Feb. 10, 2011

(54) Method for optimizing thermal energy current guidance

(75) Inventors: Thomas Fuehrer, Hagenberg (AT); Michael Weiss, Grossraming (AT)

Correspondence Address: COLLARD & ROE, P.C., 1077 NORTHERN BOULEVARD, ROSLYN, NY, 11576, US

(73) Assignee: STIWA HOLDING GMBH, ATTNANG-PUCHHEIM (AT)

(21) Appl. No.: 12/735,682

(22) PCT Filed: Feb. 6, 2009
(86) PCT No.: PCT/AT2009/000045

§ 371 Date: Sep. 13, 2010

(30) Foreign Application Priority Data
Feb. 7, 2008 (AT) A 199/2008

(51) Int. Cl. G05D 23/00

(52) U.S. Cl. 165/11.1

(57) ABSTRACT

A method for optimized thermal energy current guidance has a thermal energy source, a plurality of energy sinks and an energy circuit. In this case the amount of primary energy to be removed from the energy source is determined and a first energy sink is connected to the energy circuit and the amount of energy flow into the first energy sink is controlled. On exceeding the take up capacity of the energy sink coupled to the energy circuit, the method steps are repeated and additional energy sinks are connected. On exceeding the holding capacity of the energy sink coupled to the energy circuit the method steps are repeated and additional energy sinks are connected.

The invention relates to a method and device for thermal energy current guidance, comprising a thermal energy source, a plurality of energy sinks and an energy circuit.

Unlike other energy forms, such as for example electrical energy, thermal energy cannot be stored or at least only with great difficulty. Therefore, there is always a problem with regard to producing thermal energy or providing the latter when required or providing a suitable energy storage capacity, when thermal energy has to be transported from a source. Energy distribution systems for heating or for cooling are therefore mostly set up for the maximum expected demand, which can mean that such systems mostly do not operate at full capacity. It is known however that thermal energy provision or releasing systems are only most effective when the latter are operated in optimal operating mode, which corresponds mostly to almost the maximum capacity. If less energy is required or less energy is to be removed, such systems operate in an energetically disadvantageous partial demand range, which has a direct effect on its effectiveness and thus on economic efficiency.

Systems for transporting away thermal energy are generally known as cooling systems. In such a system the thermal energy has to be removed in order to prevent in particular the temperature of the energy source increasing beyond the permissible operating range. Such an energy source is for example a technical device, the operation of which involves a certain amount of electrical power loss, which in particular results in an increase in the operating temperature of the device. However, for reliable operation it is mostly necessary that the maximum temperature of the device or the maximum environmental temperature lies within specific limits, in particular does not exceed a maximum value.

In operating devices, such as for example data processing systems, until now mostly a heat pump has been used for cooling the environmental air and thus indirectly for cooling the operating device. As a person skilled in the art knows a coolant circulates in such a heat pump, wherein by means of compression and expansion heat transport occurs between two heat exchanger systems. Owing to the chemical properties of the coolant however the temperature range in which such a heat pump can be used is limited. A significant disadvantage is in particular that such cooling machine requires a considerable amount of operating energy, thereby worsening the entire energy balance of the operating device.

As mostly cooling takes place indirectly, in particular by means of air conditioning, it has previously been usual to reduce significantly the temperature in the operating spaces of technical devices such as data processing systems, in particular by an amount that is uncomfortable for users in such rooms. Such a strong reduction in the operating or environmental temperature requires an extremely high amount of energy and has the further disadvantage that users in such operating spaces run the risk of catching colds due to the low temperatures.

Also in systems for heating buildings or rooms systems have been used until now which due to the technical features of the room heat exchanger mostly require a very high operating temperature. In particular, heat exchangers such as for example heating bodies have been mostly designed to be particularly compact, as they are subject to existing design standards. However, in order to release a specific mount of thermal energy into a room or the environment, compact heat exchangers with a high operating temperature have to be operated. The negative effects of hot objects on the room temperature are generally known to a person skilled in the art.

Furthermore, in building technology the subject of heat removal and heat supply have largely been considered separately from one another and thus several independent, functionally similar systems are often installed. This means much greater costs and has the further disadvantage that the systems are mostly not operated in the optimum operating range.

The objective of the invention is to find a method for thermal energy current guidance, in order to divert thermal energy from an energy source such that the energy source is operated continuously in an optimum operating state.

The objective of the invention is achieved by means of a method with a thermal energy source, a plurality of energy sinks and an energy circuit, whereby the method comprises the steps described in the following.

For optimised thermal energy current guidance it is necessary to determine the amount of primary energy to be removed from the energy source. The energy source is essentially provided with a constant amount of thermal energy, however there can also be brief as well as long fluctuations in the amount of primary energy to be removed. Once the amount of primary energy to be removed has been determined the method according to the invention can perform the energy current guidance always based on the current amounts of energy.

Once it has been established that primary energy is to be removed and the amount of primary energy to be removed has been determined, a first energy sink is connected to the energy circuit. The first energy sink is designed so that at least the main proportion of the primary energy to be removed from the energy source is taken up by the first energy sink and can be released into an environment, not specified here in more detail.

An advantageous feature of the method according to the invention is also that the amount of the energy current into the first energy sink is controlled, in particular until the maximum take up capacity of the first energy sink is reached. Each energy sink can take up a specific maximum amount of thermal energy per time unit. The method according to the invention directs an amount of thermal energy per time unit into the first energy sink, corresponding to the primary energy of the energy source to be removed, in particular however only a maximum of that amount of thermal energy is directed into the energy sink that can be taken up as a maximum per time unit.

If more thermal primary energy is to be removed from the energy source than the first energy sink can absorb at maximum per time unit, the part steps of the method according to the invention are repeated, whereby however, at least one further energy sink is coupled to the energy circuit. Controlled thermal energy is directed into said additional energy sink, whereby here too the maximum take up capacity is not exceeded. If the take up capacity per time unit is not sufficient to remove the thermal primary energy from the energy source, an additional energy sink is coupled to the energy circuit and the steps are repeated as before. In particular, as many energy sinks are connected to the energy circuit as are necessary for taking up the thermal primary energy per time unit.

An energy sink is designed essentially to take up a specific amount of thermal energy per time unit and release the latter into an environment that is not specified in detail here. In particular however the amount of thermal energy that can be taken up overall by one energy sink is limited. For example, in that the primary energy taken up by the energy sink cannot be released in a sufficient amount into the environment, whereby in the energy sink there may be an unwanted and disadvantageous rise in temperature for the method according to the invention. According to the invention therefore on exceeding the take up capacity of the energy sink connected to the energy circuit, an additional energy sink is connected to the energy circuit and the method steps are repeated.

By means of the method according to the invention it is ensured that the whole amount of primary energy to be removed from the energy source is directed into the energy sinks, whereby in an advantageous manner it is also ensured that only those energy sinks are connected to the energy circuit which taking into consideration the maximum take up capacity, can absorb the amount of thermal primary energy to be removed from the energy source. In this way in a particularly advantageous manner only the energy sink or sinks is/are coupled to the energy circuit, which with respect to their holding or take up capacity correspond as optimally as possible to the amount of primary energy to be removed from the energy source.

The measurement of a first temperature of the energy circuit for determining the amount of primary energy to be removed ensures in an advantageous manner that the method according to the invention is only active when thermal primary energy needs to be removed. By means of external influences the thermal energy source could for example adopt an operating status in which only a very small amount of thermal primary energy needs to be removed. Furthermore, it is also possible that for a short time large amounts of thermal primary energy have to be removed. Both result in a change in the temperature of the energy circuit, whereby by measuring a first temperature such a change in the amount of primary energy can be reliably established. In particular, it is an advantage if the first temperature is measured at a transfer point of the energy source on the energy circuit. As via the energy circuit there is a distribution of the thermal energy, in particular cooling or heating tasks are performed, it is an advantage if the first temperature is measured where the energy source transfers the thermal primary energy to the energy circuit. In particular, this detecting position is selected such that a reliable determination of the energy ratios in the energy source, in particular the temperature is ensured. With regard to a design in which the method according to the invention is used at least partly for heating a room or building, the design has the further advantage that the temperature of the energy-transporting medium can be easily determined, as in particular as far as possible a constant temperature is desirable in the energy circuit.

An embodiment is also advantageous in which the determination of the amount of the primary energy to be removed involves measuring a second temperature of the energy circuit. By measuring a second temperature, which is measured particularly preferably at a transfer point of the energy circuit at the energy source, it is ensured that in the energy circuit a sufficient amount of thermal primary energy is released to energy sinks and thus the temperature of the heat transport medium flowing back into the energy source lies in a fixed range. By measuring the temperature of the medium flowing back into the energy source in a particularly advantageous manner also the energy source operates at a largely constant temperature level, which is very important for operational safety.

According to a further development the amount of primary energy is determined from the temperature difference between the first and second temperature and the measurement of the volume flow in the energy circuit. Energy transport systems react mostly very slowly, in particular fluctuations in the energy provision of the energy source often occur with a significant time delay in the energy sink. An embodiment according to the claims therefore has the particular advantage that fluctuations in the energy circuit can be established early and very precisely, whereby a rapid reverse control is possible. In particular, by means of the method according to the claims it is possible to estimate or detect early which of the possible energy sinks is to be connected to the energy circuit and to what extent.

A particularly advantageous development is obtained, if the volume flow is controlled to be directly proportional to the amount of primary energy to be removed. As the amount of thermal energy to be transported is substantially dependent on the volume flow of the energy transport medium, this design has the advantage that the volume flow can be adjusted directly to the amount of thermal primary energy to be transported, and thus stable temperature ratios can be ensured in the energy circuit and in the energy source. Stable temperature levels, in particular the first and second temperature, are a particular advantage for the most efficient energy transport from the energy source to the energy sink and in particular the optimal energy take up into the energy sink. Unlike known methods, in which usually the volume flow is kept constant in the energy circuit and thus with a fluctuating amount of primary energy also fluctuating temperature levels can be set in the energy circuit, a design of the method according to the invention has the particular advantage, that a significantly simple control of the energy transport is possible and thus the temperature levels in the energy circuit can be kept particularly stable.

It is particularly advantageous if the method according to the invention for selecting the first energy sink can refer to at least one climatographic dataset on the local site. As in the method according to the invention a plurality of different energy sinks can be coupled to the energy circuit and the individual energy sinks have different take up and absorption behaviours, the selection of the first energy sink is of particularly importance for the efficiency of the method according to the invention. A climatographic data set can for example include only information about an average environmental temperature, based for example on the current season, however a degree of detail is possible which includes the current climate parameter, for example temperature and moisture variation as well as sun radiation. From a suitably designed climatographic data set for example it can be decided in the medium term, into which energy sink the primary energy is to be directed. The main difference as to whether the method according to the invention should in principle perform a heating or cooling task is particularly important. Thus during a hot period, for example in the summer, the primary energy of the energy source is directed into an energy sink, which even in summer environmental temperatures has a sufficient heat take up capacity. In colder periods the primary energy is preferably directed into those energy sinks, which allow the release of the thermal primary energy into a building or into a room. The very particular advantage of the method according to the invention is that the temperature levels in the energy circuit, in particular the first and second temperature are largely identical both in cold periods and hot periods. In particular, in this way the transport of thermal primary energy from the energy source is as independent as possible from climatographic influences, in particular without the energy circuit having to be adjusted to the environmental conditions or the respective energy sinks.

It is therefore particularly advantageous if according to one development the order of the coupling of the additional energy sinks is controlled by a saved hierarchical profile, as in this way in a targeted manner those energy sinks can be connected to the energy circuit which under the prevailing environmental conditions are designed in an optimal manner for taking up the primary energy to be removed from the energy source. In particular, in a hierarchical profile information can saved about which amount of energy or which maximum energy flow a specific energy sink can take up, and if necessary the climatographic conditions in which the energy sink operates most effectively. Particularly advantageous with respect to advance planning or temporary control by means of the design according to the claims the load profile can be designed such that the temperature level in the energy circuit is kept as constant as possible.

With regard to the reliability and dependability of the method according to the invention it is particularly advantageous if the volume flow is monitored and an alarm is triggered if a limit value is fallen below. Owing to technical failure it may occur for example that a media transport device arranged in the energy circuit adjusts its function and there may be a stoppage of the volume flow in the energy circuit. If this kind of failure of the energy transport is not detected rapidly, the primary energy is no longer removed from the energy source, which can lead to an impermissible rise in temperature in the energy source, which in turn can lead to damage to the energy source. A design according to the claims ensures that in the case of failure of the volume flow, in particular if a limit value is fallen below precautions have to be taken which ensure a reliable operating state of the energy source.

Similarly with respect to a reliable function or high operational safety of the method according to the invention it is advantageous if the first and/or second temperature is monitored and a warning signal is given if at least one saved limit value is exceeded and/or fallen below. By monitoring the first and/or second temperature the operating status in the energy circuit can be determined very well. However, for a reliable operation of the energy source it is of considerable importance that specific temperature levels are maintained, in particular that specific temperature limit values are not reached or exceeded or fallen below. For the first and/or second temperature however also several limit values can be saved, which if exceeded or fallen below can cause a multi-stage warning. For example, if a first limit value of the first temperature is exceeded a warning is triggered, which provides the user with a brief message about exceeding a limit value. In the case of a further rise in temperature and thus exceeding a second limit value a second warning stage is reached, in which for example a device is activated, which automatically brings the energy source into a safe operating state.

According to a further development the first and/or second temperature is monitored and on exceeding a saved limit value a high-performance energy sink is coupled to the energy circuit. According to the method of the invention a plurality of energy sinks is coupled to the energy circuit, in order in this way to transport the primary energy to be taken from the energy source into the energy sinks. Once the energy sinks have reached their take up capacity or if an unexpectedly high amount of primary energy is to be transported off it can occur that the temperature level in the energy circuit, in particular the first temperature, exceeds an operationally critical limit value. In an advantageous manner according to the claims a high performance energy sink for example an air conditioning device is connected to the energy circuit and thus ensures the reliable maintenance of the temperature level in the energy circuit.

The objective of the invention is also achieved by a device which comprises an energy source, a plurality of energy sinks and an energy circuit. The particularly advantageous features of the device according to the invention are that each energy sink is coupled via a controllable branch connection to the energy circuit and that the heat transport medium flows through the energy source, the energy circuit and the sinks.

A controllable branch connection is particularly advantageous in that it can be determined precisely what amount of thermal energy is directed from the energy circuit into the energy sink and in this way the temperature level in the energy circuit and in particular in the energy source and the energy sink can be controlled very precisely. In particular, the controllable branch connection is designed such that the volume flow can be diverted from the energy circuit into the energy sink in a controllable manner. Thus the heat transport medium after flowing through the energy sink and releasing a main proportion of the transported amount of heat with reduced temperature is introduced back into the energy circuit and flows back following the energy circuit in the direction of the takeover point of the energy source.

A further very special advantage is achieved if the heat transport medium flows through all components of the device according to the invention as in this way a much simpler structure is possible, in particular no additional heat exchangers or heat pumps are necessary for adjusting different temperature levels or different heat transport media. The device according to the invention has the further special advantage that despite having a simple and compact structure a reliable removal of thermal energy from an energy source to a plurality of energy sinks is possible. It is particularly advantageous that owing of the one transport medium and the plurality of energy sinks the device according to the invention can have both a cooling and a heating function.

According to advantageous developments a first temperature sensor is arranged at the transfer point and a second temperature sensor is arranged at the takeover point. By means of this design it is ensured that at defined interfaces between the energy source and the energy circuit, a temperature sensor is arranged, by means of which the temperature can be determined at these interfaces. Determining the temperature at these marked points in the energy circuit makes it possible in an advantageous manner to consider the energy source and the energy sinks connected to the energy circuit to be largely independent of one another. The selection of the energy sink to be coupled to the energy circuit is also dependent on the first temperature, the so-called running-in temperature. A reliable operation of the energy source can also be achieved by monitoring the first temperature, in particular the first temperature may not exceed a fixed limit value. If the energy sinks coupled to the energy circuit are no longer in a position or are only insufficiently in a position to take up the primary energy emitted by the energy source, this causes a rise in the second temperature, the so-called return temperature. As according to the claims also this second temperature is monitored, thus a reliable monitoring of the operating status of the energy circuit is possible. As it is particularly important for the reliable operation of the energy source, if the latter is operated in a specific temperature range, it is a particular advantage if at the same time the temperature of the emitted energy flow and the temperature of the returning energy flow can be determined.

To achieve a high degree of operational safety and determine the removed amount of heat an embodiment is advantageous in which in the energy circuit a volume flow device is arranged. By means of this detecting means on the one hand it is possible to determine the heat flow, in which from the difference in temperature between the first and second temperature and the volume flow the amount of primary energy is determined. The detecting means has the further advantage that an operational disruption in the energy circuit for example the failure of a medium transport pump can be recognised immediately and therefore suitable counter measures can be taken.

According to an advantageous development the energy sink can be designed for example as a heating system, as a construction element of a building and as a heat exchanger, whereby combinations thereof are also included. A heating system as an energy sink according to the claims comprises all of those systems, which are designed to heat a housing or a room. For example the latter could be radiation and/or convection heating bodies, automatic air convectors or the like. In any case the heating system has to be in a position to achieve at the temperature level of the heat transport medium a sufficient release of energy into the surrounding room.

Whereas heating systems are designed in particular to release thermal energy into a room or a building, the construction elements of a building are preferably designed to give off thermal energy to the environment, without requiring forced air guiding for example by ventilators. Such construction elements can comprise all of the components of a building, which are used for the structural design or an optical and/or functional design and are in contact with the surrounding air. Heat exchangers are designed to transport thermal energy from the energy circuit into a different medium. For example, by means of the heat exchanger thermal energy can be released from the energy circuit to a water reservoir or by means of earth probes or earth foundations into the surrounding ground.

The particular advantage of a design of the energy sink as a heating system is that the primary energy does not have to be removed in a complex manner using large amounts of energy, and the latter can be used keeping a building or a room at the right temperature. Structural elements or heat exchangers as energy sinks have the particular advantage, that over a longer period they can absorb very large amounts of energy and release it into the environment, without requiring additional energy, in particular electrical energy, for example for fans.

A particularly advantageous development is obtained if the heating system is formed by concrete core-activated construction components, as in this way the heating system can be integrated without additional effort or without additional assembly steps directly during the construction of a building. In known heating systems mostly a type of heat exchanger is arranged after the structural completion of the building or room. This requires additional steps and due to the required space requirement can lead to structural restrictions. Concrete core-activated components have the particular advantage that the heat exchanger can be integrated into the latter during the production of a component and is thus available during the installation. As construction components are mostly standardised and therefore can be largely mass-produced, the design according to the claims makes it possible to achieve a significant reduction in the costs of manufacturing a heating system.

Particularly advantageous developments are obtained, if the first temperature is less than 30° or if the second temperature is less than 25°. By means of these two temperature levels it is ensured in a particularly advantageous manner that the energy sinks of the devices according to the invention take up thermal energy at this temperature level and release it into the environment. In particular it is ensured in this way that in the energy circuit no temperatureadjusting device is required and thus the heat transport medium flows through the energy source flows and via the energy circuit the energy sinks. Owing to the temperature level according to the claims it is also ensured in an advantageous manner, that no complex treated heat transport medium is required, preferably a suitably treated water is used. A heat transport medium with a first temperature according to the claims can thus be directed in a particularly advantageous manner directly into a heating system.

According to one development the energy source is formed by a data processing device. A data processing device produces during correct operation a specific amount of waste heat, which has to be removed to maintain the reliable operation of the data processing device. In known cooling systems this removal takes place by cooling the air surrounding the data processing device, whereby the surrounding temperature is usually reduced very significantly, to ensure the reliable cooling of the devices. The device according to the invention now has the advantage that a data processing device can be operated safely and reliably and that at the same time the waste heat produced can be released directly to a remote environment, whereby the temperature levels in the energy circuit are such that no temperature adjustment is necessary. In particular, the waste heat of the data processing device is used for the direct heating of a room or building and also the waste heat can be released reliably into the environment by means of natural convection. The particular advantage of the design according to the invention is that despite raising the temperature level in the energy circuit above the previously known level, a data processing device can operate more safely and reliably. The data processing device can be formed for example by a plurality of data processing systems such as a personal computer or server-systems.

According to further developments the energy source is formed by a production device and at least one electrical supply, control and regulating device. Also for production devices the device according to the invention can be used in a particularly advantageous manner, as here too the temperature level can be raised in the energy circuit to cool the production device, without there being a restriction or worsening of the operation of the production device. An electrical supply, control and regulating device is also known as a so-called control cabinet or control cabinet arrangement and comprises a plurality of different, mostly electronic components, which supply for example a production device with energy and control information.

According to an advantageous development a high-power energy sink is arranged in the energy circuit. Such an energy sink is formed for example by a heat pump or an air conditioning device and introduces an additional device for maintaining the operational safety into the energy circuit. Such a high-power energy sink can be activated for example when the primary energy to be removed can no longer be taken up by the energy sinks connected to the energy circuit and causes a dangerous increase in the temperature level of the energy circuit. An embodiment is particularly preferable in which the high-power energy sink is only connected if necessary to the energy circuit, i.e. only upon a dangerous increase in the temperature level.

An advantageous development is provided by an embodiment in which in the energy circuit a media transport device is arranged, which is designed in particular as a pump with or for the control of the volume flow. An essential feature of the device according to the invention is that the temperature level in the energy circuit, in particular the first and second temperature is largely constant. As the amount of primary energy to be removed from the energy source can fluctuate the design according to the invention has the particular advantage that the volume flow is adjusted specifically so that the temperature level in the energy circuit is kept largely constant. In particular, by adjusting the volume flow a very good control of the thermal energy transport is possible.

For the reliability of the device according to the invention a design is particularly advantageous in which the branch connection comprises an emergency circuit. In the case of an operational failure, in particular in the case of a power cut it is particularly important for operational safety, for the energy flow in the energy circuit to be maintained for at least a specific period. As the controllable branch connection for guiding the volume flow mostly requires a form of operating energy, preferably electrical energy, but the latter in the case of an operational disruption is possibly not available, it is ensured in a design according to the invention that the branch connection remains in a defined position of rest and thus a reliable transport of energy from the energy source is possible. According to a development the energy source is formed by a data processing device or a production device, which in the case of operational failure is mostly supplied with electrical energy by means of an independent energy supply, and in this way also produces waste heat which also has to be removed. In the design according to the claims the branch connections of the energy sinks would adopt a defined position of rest and enable a reliable removal of heat from the energy source.

The invention is explained in more detail in the following with reference to the exemplary embodiments shown in the drawings.

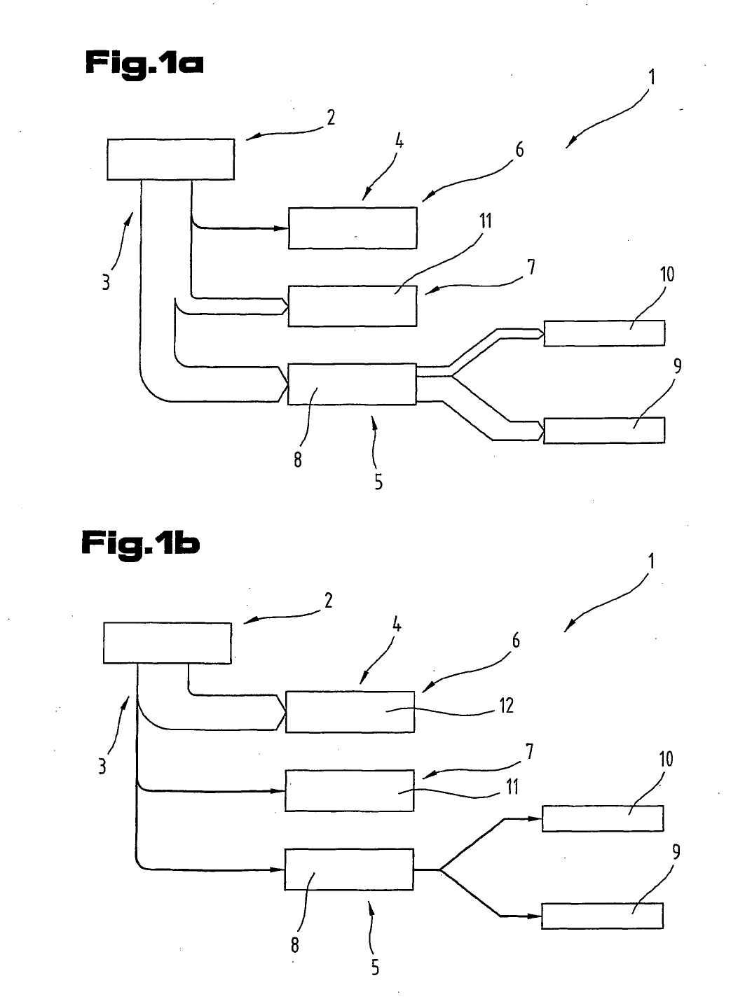

FIG. 1 a), b) show schematically the guidance of the thermal primary energy flow from the energy source to the energy sinks;

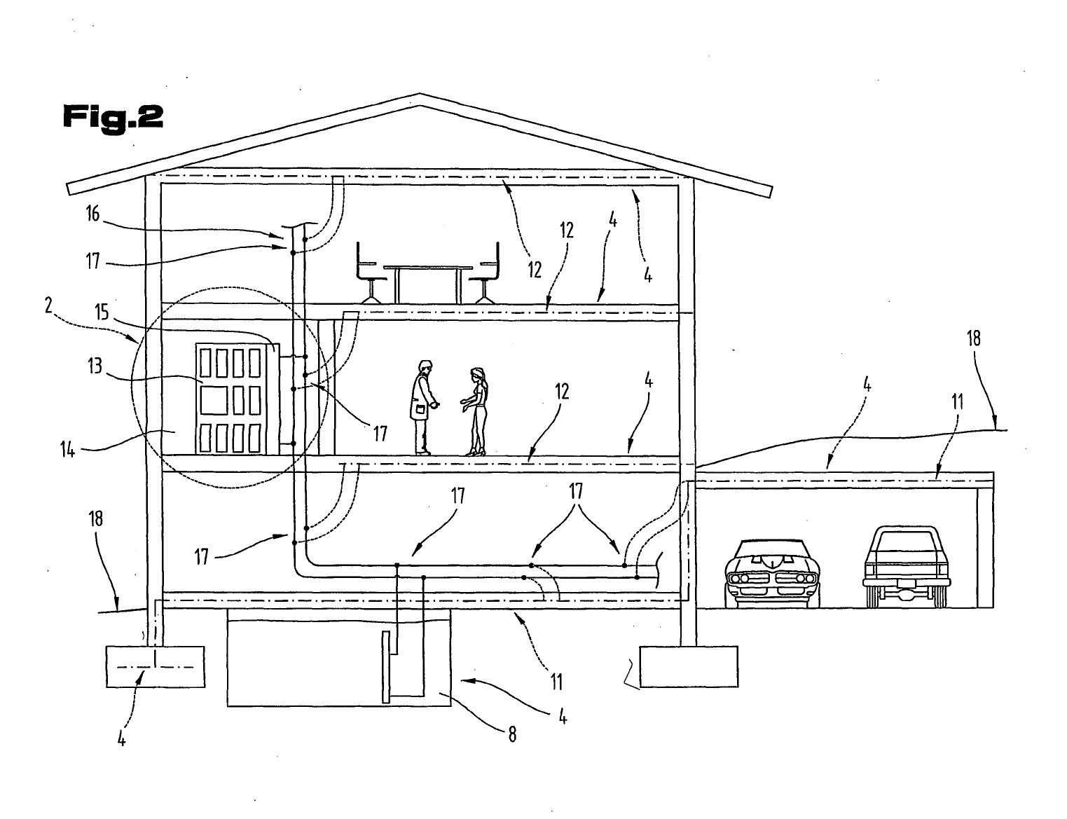

FIG. 2 shows the use of thermal energy flow guidance in an office building;

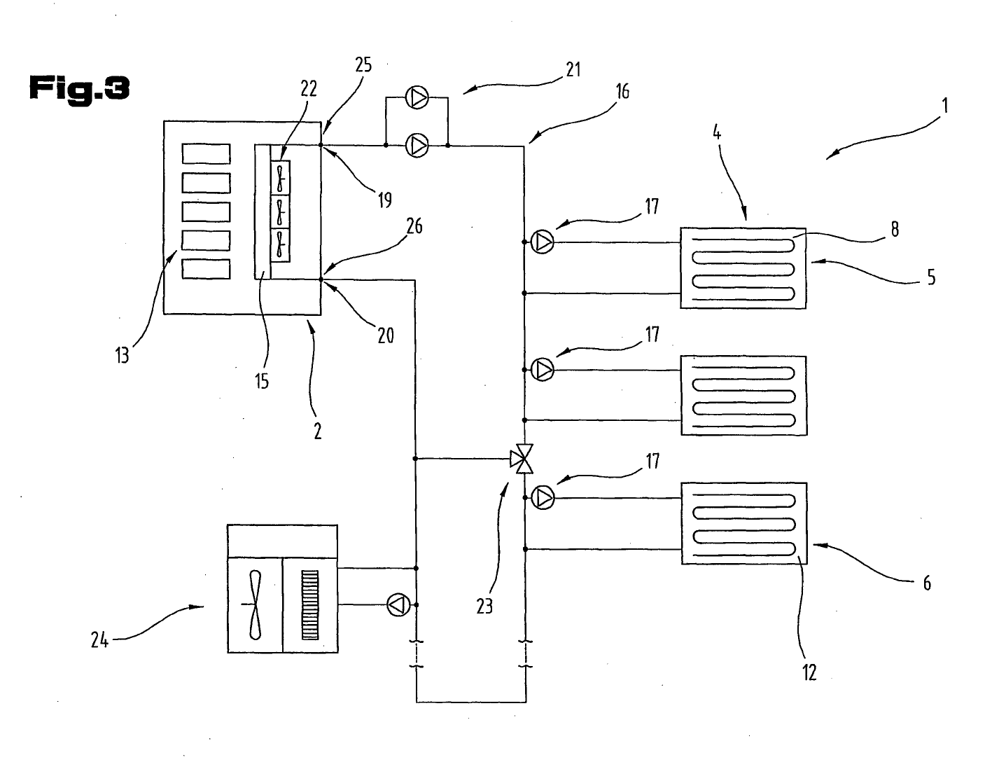

FIG. 3 shows a schematic view of the energy circuit.

First of all, it should be noted that in the variously described exemplary embodiments the same parts have been given the same reference numerals and the same component names, whereby the disclosures contained throughout the entire description can be applied to the same parts with the same reference numerals and same component names. Also details relating to position used in the description, such as e.g. top, bottom, side etc. relate to the currently described and represented figure and in case of a change in position should be adjusted to the new position. Furthermore, also individual features or combinations of features from the various exemplary embodiments shown and described can represent in themselves independent or inventive solutions.

All of the details relating to value ranges in the present description are defined such that the latter include any and all part ranges, e.g. a range of 1 to 10 means that all part ranges, starting from the lower limit of 1 to the upper limit 10 are included, i.e. the whole part range beginning with a lower limit of 1 or above and ending at an upper limit of 10 or less, e.g. 1 to 1.7, or 3.2 to 8.1 or 5.5 to 10.

FIGS. 1a and 1b show in a much simplified form the method according to the invention for optimised thermal energy flow guidance 1. From an energy source 2 an amount of primary energy 3 is produced and has to be removed from the latter, whereby the primary energy 2 is guided into a plurality of energy sinks 4 such that for example depending on a climatographical dataset the first energy source 5 or 6 is selected, and thermal energy is directed into the latter until the take up capacity thereof is reached.

The amount of primary energy 3 provided by or to be removed from the energy source 2 is largely constant, but is subject however to short-term and long-term temporal fluctuations. A basic criteria for selecting the first energy sink 5, 6 is information on the current climate perio, in particular whether the primary energy has to be removed to an environment or whether the primary energy can be released into the building. In the following the release of primary energy into the environment is defined as cooling or summer operation and the release to or into the building is defined as heating or winter operation. Knowledge of the corresponding mode of operation is absolutely essential for the reliable running of the method according to the invention and thus also for acceptance by the user or operator.

FIG. 1a shows summer operation, where most of the primary energy 3 is directed into the first energy sink 5 and the remaining portion of primary energy is directed into a second energy sink 7. The first energy sink 5 is preferably formed by a cooling tank 8, which comprises essentially a container filled with water. Such a cooling tank is formed in a particularly preferable manner by a used water collector, which is used for holding surface water and provides water outlet points, in which no drinking water is required. In an office building with a conventional water supply a large proportion of the required drinking water is not used as such, but is used predominantly as transport removal medium, for example in WC systems. A cooling tank 8, as used in the method 1 according to the invention, now combines a very environmentally friendly use of surface water, which has to be diverted or collected for structural physiological reasons, with the diversion of a portion of the primary energy 3. Used water systems are therefore supplied with heated water, which is also a particular advantage with regard to its cleaning effect. For storage reasons such used water supply systems usually have a very large volume, whereby they mostly also have a very high energy take up capacity.

If necessary the first energy sink 5 can comprise additional components, for example a greater proportion of the primary energy can be lead off by means of a well return cooling 9 into the surrounding ground. It is also possible to cool by means of a surface cooling element 10, for example a roof or cover construction or a cooling tower can be used for cooling, in which by means of such a construction element heated water is directed out of the cooling tank and thus releases heat into the environment. In the case of well cooling 9 for example deep bores are made into the ground and a heat exchanger is arranged in the latter through which heated water of the cooling tank flows and thus the heat is released into the surrounding ground.

The second energy sink is preferably formed by a construction element of a building and is preferably designed as a so-called cooling cover 11. Such a construction element can be considered to be a component of a support structure of a building and is therefore mostly designed to be solid and voluminous. In particular, such a construction element is in contact with the surrounding air, whereby direct exposure to sun radiation should be avoided. For example, such cooling covers can be wall or ceiling elements of garages, in particular underground garages, which over their mostly large area can emit a sufficient amount of thermal energy to the environment. A particular advantage of this embodiment is that for releasing energy into the environment no forced air guiding is required but the structural conditions are sufficient so that even in summer with increased environmental temperatures, sufficient energy can be released into the surrounding air. Construction elements which are used for garages, in particular if the latter are located inside or underneath a building, have the further very particular advantage that due to the largely constant temperature of the ground excellent heat removal is possible.

FIG. 1b shows the winter operation in which the main proportion of the primary energy 3, preferably all of it, is directed into the first energy sink 6. During winter operation the first energy sink 6 is preferably formed by a heating system 12, in that the introduced thermal energy is released into a building or individual rooms in a controlled manner.

Owing to climatographic conditions it may also occur during winter operation that the primary energy 3 of the energy source 2 to be removed cannot be diverted completely via the first energy sink 6 to the building or the rooms, so that it is necessary to connect an additional energy sink 3 to the energy circuit.

The very special advantage of the method according to the invention is that both in summer and in winter operation the primary energy 3 emitted by the energy source 1 or to be removed is directed in an optimally controlled manner into a first energy sink 5, 6, so that in any case all of the primary energy 3 is diverted from the energy source 2, without in the energy circuit or the energy source an adjustment being necessary to the conditions with respect to the selection of the first and possibly additional energy sinks coupled to the energy circuit. In particular, it is especially important that temperature levels in the energy circuit are largely identical regardless of the respective operation. According to a preferred embodiment the energy source is formed by a data processing device, in which a plurality of data processing systems are arranged in a common housing or in a room and release their waste heat into the environment. With such data processing devices until now it has been known to cool the room to a high degree in order to indirectly keep the operating environmental temperature around the data processing device suitably low. On the basis of recent investigations, which have also resulted in the method according to the invention, it has been established in an advantageous manner that known data processing devices do not have to be cooled anywhere near as much to provide the requirements for the reliable operation of data processing devices. In particular, the environmental temperature around the data processing device can be increased such that the temperature of the heat transporting medium is sufficient in winter operation to be fed directly into a heating system and also during the summer operation the release of energy to the environment is possible without forced ventilation, in particular without cooling machines. To transfer the waste heat of the data processing devices into the energy circuit the energy source comprises an air-liquid heat exchanger, which is flowed through by the heated output air of the data processing device and releases thermal energy to the heat transport medium in the energy circuit.

The particular advantage of the method according to the invention is that the heat transport medium flows through the heat exchanger of the energy source, the energy circuit and the energy sinks and thus no additional technical devices are required in particular for adjusting different temperature levels.

According to a further advantageous development the energy source can be formed by a heating pump. In particular, all devices are possible as an energy source, in particular also combinations thereof, which are known to a person skilled in the art for generating or emitting thermal energy. Thus for example, fluctuations of a first energy source by the specific control of a second energy source are balanced, whereby a largely constant amount of thermal energy is released to the energy circuit.

FIG. 2 shows a schematic representation of a device for optimised thermal energy current guidance, as could be used in an office building. The energy source 2 is preferably formed by a data processing device 13 comprising several data processing systems, which device releases the arising waste heat into the surrounding room 14, whereby the air temperature in the room is increased. A heat exchanger 15, in particular an air-liquid heat exchanger, is flowed through by the heated room air, removes said heat and transfers it to the flowing heat transport medium. The energy source is connected to the energy circuit 16, in particular the energy transport medium flows through the energy circuit and the heat exchanger of the energy source. A plurality of energy sinks 4 are connected to the energy circuit 16 in a controllable manner. The branch connections 17 are designed in this case such that a controllable amount of the heat transport means can be diverted from the energy circuit 16 into the respective energy sink 4.

An energy sink is formed for example by a heating system 12, particularly preferably by concrete-activated components. In concrete-activated components by adhering to structural requirements a guiding system is arranged on the inside of the component, which is flowed through by the energy transport medium and the component is thus heated from the inside out. The energy sink can however also be formed by construction elements, for example as ceiling or wall elements for a garage. It is particularly advantageous if a room such as a garage is partly in contact with the ground or is surrounded predominantly by soil, for example if a garage is arranged partly or completely underneath a building 18. The natural convection in such a room is then sufficient so that a cooling ceiling 11, which can release thermal energy released from the energy circuit 16 into the environment. The term cooling ceiling comprises in this connection all components, which are in direct contact with the surrounding air and thus enable a release of heat into the environment, but which are not exposed to direct sun radiation. The components are therefore mainly oriented in North-East direction, depending on the respective site. Preferably, such a cooling ceiling up to about 26° C. external temperature as an energy sink is connected to the energy circuit, as up to this temperature a sufficient release of heat to the environment is possible.

In energy sinks that are in contact with the environmental air due to structural measures it may occur that the component temperature falls below freezing point. As in the energy circuit preferably water is used as the heat transport medium, at such temperature levels there is a risk of the energy circuit freezing up or the energy sink. Therefore, in the energy circuit a heat exchanger can be arranged, preferably a liquid-liquid heat exchanger, whereby in the releasing energy circuit a suitable frost-free heat transport medium circulates.

The energy sink can also be designed as a cooling tank 8, whereby in this case the energy of the energy transport medium in the energy circuit 16 is released by means of a liquid-liquid heat exchanger into the water in the cooling tank. For structural reasons the cooling tank is preferably arranged underground, whereby via the edging of the tank a release of energy is possible to the surrounding earth. By having suitable volume dimensions a cooling tank with a very high thermal take-up capacity can be formed.

A further particular advantage of the method according to the invention is also that via the energy circuit not only the waste heat of the energy source 2 can be transported to a plurality of energy sinks 4, but also thermal energy can be transported between energy sinks. In particular, it is also possible to use the heating system 12 in summer operation for cooling the building, in that a proportion of the returning and cooled energy transport medium, is directed not only into the energy source 2 but also into the heating system 12. By means of this advantageous development the method according to the invention has a further economical advantage, as no additional expensive cooling machinery is necessary for cooling rooms during summer operation, and it is possible to cool the data processing device and the building by means of the same method according to the invention.

The very particular advantage of the method according to the invention is shown in that by raising the temperature of the heat transport medium emitted by the energy source the data processing device giving off heat can be cooled sufficiently for a reliable operation in each case, in winter operation the building can be heated and in summer operation the building can be cooled, without expensive and high energy-consuming cooling machines being necessary. The method according to the invention thus has considerable advantages over known methods with respect to environmental impact and costs.

FIG. 3 shows a schematic representation of the device according to the invention for thermal energy current guidance, comprising an energy source 2, an energy circuit 16 as well as a plurality of energy sinks 4. The energy source 2 is formed by a data processing device 13 and for transferring the heated environmental air to the energy transport medium in the energy circuit 16 comprises a heat exchanger 15. The heat exchanger 15 is flowed through by the energy transport medium, whereby said medium is transferred to a transfer point with a first temperature 19, in particular the starting temperature, to the energy circuit 16 and at a takeover point is taken over at a second temperature 20 from the energy circuit. For transporting the medium in the energy circuit 16 at least one media transport device 21 is arranged, whereby the latter is preferably designed redundantly as a liquid pump, in order to provide a functional pump device. A plurality of energy sinks 4 can be connected to the energy circuit 16. The branch connections 17 are thus designed such that a specific amount of the heat transport medium can be diverted out of the energy circuit into the energy sink. The heat transport medium therefore flows through the energy sink 4, transfers thermal energy to the latter and flows back into the energy circuit 16. If the take up capacity or the take up ability of an energy sink has been reached, there is an increase in the second 20 and then also the first 19 temperature. As the first and second temperatures are monitored, automatically a further energy sink is coupled in a controlled manner to the energy circuit, until the second and first temperature are back in the permissible range.

The heat exchanger 15 preferably comprises a forced air guide for example a ventilator 22, in order to guide the heated air to the heat exchanger elements. In a preferred development the speed of the fan 22 can be controlled, whereby in a particularly advantageous manner the temperature of the environmental air can be kept constant very easily. If necessary, also a plurality of fans can be provided, whereby the amount of air is then controlled by the regulated start up of the individual fans 22.

As the energy source 2 can comprise a data processing device 13, the environmental temperature in the operating room of the energy source has to be kept in any case within permissible limits. The standards according to IEC 68-2-1 and IEC 68-2-2 set reliable environmental conditions for servers and small devices. For example according to IEC 68-2-1 the permissible environmental temperatures for operating data processing devices are in the region of 10° C. to 35° C. According to IEC 68-2-2 the values are in the region of 5° C. to 40° C., and respectively 20% to 80% relative air moisture, non-condensing.

In the method according to the invention the energy circuit 16 is controlled such that the temperature of the incoming air, i.e. the air suctioned from the heat exchanger 15 is 33° C. and thus the requirements of IEC 68-2-1 and IEC 68-2-2 are met. The same applies to the air emitted by the heat exchanger, the so-called output air, the temperature of which is set to 27° C.

Said temperature levels ensure on the one hand the reliable operation of data processing devices according to an internationally recognised standard and on the other hand allow the transfer of the amount of thermal primary energy to the environment without forced air guiding being necessary or allow the direct operation of a heating system for a building or a room.

If for any reason insufficient thermal energy is removed the environmental temperature around the data processing device will increase. If the temperature of the air suctioned from the heat exchanger reaches the limit according to IEC 68-2-2 of 40° C., or if the removed air reaches a limit of 30° C., a warning state is reached which informs a user about the increased temperature level. If the temperature increases further to e.g. 45° C. incoming air and 33° C. outgoing air, emergency scenarios are activated automatically in order to lower the temperature of an energy circuit. For example, an additional cooling machine could run automatically and remove the thermal energy or the data processing device could automatically be shifted into an energy saving state.

Owing to unavoidable transfer losses between the air and the energy transport medium the temperature levels of the energy transport mediums are below that of the air. In particular, the return temperature 20 is set to 22° C. At a starting temperature 19 of 25° C. a warning state is reached, at 26° C. an alarm is triggered. The thus activated processes correspond to the ones described above.

The given temperature levels are kept within control engineering limits, but slight variations are also possible. Also other temperature levels can be set, whereby the guidelines according to standards IEC 68-2-1 and IEC 68-2-2 are still adhered to.

It is also possible to control the moisture in the air which is directed around the data processing device for energy removal. In this case the waste air is moistened specifically, flows through the data processing device and is heated thereby. Before passing through the heat exchanger the heated air is dehumidified, preferably by means of non-mechanical drying means, whereby the heat of the transported water vapour is freed and thus significantly heated air flows through the heat exchanger.

To reduce the flow resistance in the energy circuit 16 the branch connections 17 are optimised so that in the non-connected state they have the lowest possible flow resistance. If the energy take up capacity of an energy sink is sufficient bridging connections 23 can be arranged in the energy circuit, in order to reduce the line length of the energy circuit and thereby the flow resistance in an advantageous manner.

If necessary a cooling machine 24 can be connected to the energy circuit, in order to be available in climatographic extreme situations or with a much increased amount of thermal primary energy as an additional safety element for forced cooling. As such a cooling machine is used exclusively for covering peaks and thus mostly only has to remove a small amount of energy it can be designed to be suitably compact.

The exemplary embodiments show possible embodiment variants of the method for optimised thermal energy current guidance, whereby it should be noted at this point that the invention is not restricted to the embodiment variants shown in particular, but rather various different combinations of the individual embodiment variants are also possible and this variability, due to the teaching on technical procedure, lies within the ability of a person skilled in the art in this technical field. Thus all conceivable embodiment variants, which are made possible by combining individual details of the embodiment variants shown and described, are also covered by the scope of protection.

FIG. 3 shows an additional and if necessary an independent embodiment of the device for optimised thermal energy current guidance, whereby for the same parts the same reference number and component names have been used as in the preceding FIGS. 1 and 2. To avoid unnecessary repetitions reference is made to the detailed description given for the preceding FIGS. 1 and 3.

Finally, as a point of formality, it should be noted that for a better understanding of the structure of the method for optimised thermal energy current guidance the latter and its components have not been represented true to scale in part and/or have been enlarged and/or reduced in size.

The problem addressed by the independent solutions according to the invention can be taken from the description.

Mainly the individual embodiments shown in FIGS. 1 to 3 can form the subject matter of independent solutions according to the invention. The objectives and solutions according to the invention relating thereto can be taken from the detailed descriptions of these figures.

### LIST OF REFERENCE NUMERALS

1 Method for optimised thermal energy current guidance
2 Energy source
3 Primary energy
4 Energy sink
5 First energy sink in summer operation
6 First energy sink in winter operation
7 Second energy sink
8 Cooling tank
9 Well cooling energy sink
10 Cooling roof, cooling tower
11 Cooling cover
12 Heating system
13 Data processing device
14 Room
15 Heat exchanger
16 Energy circuit
17 Branch connection
18 Terrain level line
19 First temperature
20 Second temperature
21 Media transport device
22 Fan
23 Bridging connection
24 Refrigeration machine, high-power
25 Transfer point
26 Take up point

1-24. (canceled)

25. Method for optimized thermal energy current guidance comprising at least one thermal energy source, a plurality of energy sinks and an energy circuit, comprising the steps
determining the amount of primary energy to be removed from the energy source by;
measuring a first temperature and a second temperature of the energy circuit;
determining a temperature difference between the first and second temperature;
measuring the volume flow in the energy circuit;
determining the amount of primary energy from the temperature difference and the volume flow;
coupling a first energy sink to the energy circuit;
controlling the amount of energy current into the first energy sink until the take up capacity of the first energy sink is reached;
on exceeding the take up capacity of the energy sink connected to the energy circuit, repeating the steps for the additional energy sinks;
on exceeding the holding capacity of the energy sink coupled to the energy circuit, repeating the steps for the additional energy sinks.

26. Method according to claim 25, wherein the volume flow is controlled to be directly proportional to the amount of primary energy to be removed.

27. Method according to claim 25, wherein the first energy sink is selected on the basis of at least one climatographic dataset of the local site.

28. Method according to claim 25, wherein the order of the coupling of the additional energy sinks is controlled by a saved hierarchy profile.

29. Method according to claim 25, wherein the volume flow is monitored and on falling below a limit value an alarm is triggered.

30. Method according to claim 25, wherein the first and/or second temperature is monitored and on exceeding and/or falling below at least one saved limit value a warning is emitted.

31. Method according to claim 25, wherein the first and/or second temperature is monitored and on exceeding a saved limit value a high power energy sink is coupled to the energy circuit.

32. Device for thermal energy current guidance in particular according to claim 25, comprising an energy source, a plurality of energy sinks and an energy circuit, wherein the energy circuit comprises a heat transport medium and a line system, wherein the energy source at a transfer point transfers a heat transport medium to the energy circuit and picks it up against at an take up point, wherein each energy sink is coupled by a controllable branch connection to the energy circuit and the heat transport medium flows through the energy source, the energy circuit and the energy sinks.

33. Device according to claim 32, wherein a first temperature sensor is arranged at the transfer point

34. Device according to claim 32, wherein a second temperature sensor is arranged at the take up point.

35. Device according to claim 32, wherein in the energy circuit at least one detecting means is arranged for the volume flow.

36. Device according to claim 32, wherein the energy sink is formed from a group comprising a heating system, construction element of a building, heat exchanger.

37. Device according to claim 36, wherein the heating system is formed by concrete core-activated building construction components.

38. Device according to claim 32, wherein the first temperature is less than 30° C.

39. Device according to claim 32, wherein the second temperature is less than 25° C.

40. Device according to claim 32, wherein the energy source is formed by a data processing device.

41. Device according to claim 32, wherein the energy source is formed by a production device.

42. Device according to claim 32, wherein the energy source is formed by at least one electrical supply, control and regulating device.

43. Device according to claim 32, wherein in the energy circuit a high-power energy sink is arranged.

44. Device according to claim 32, wherein in the energy circuit at least one media transport device is arranged which is designed for controlling the volume flow.

45. Device according to claim 32, wherein the branch connection comprises an emergency circuit.
